(19) United States
(12) Patent Application Publication
(10) Pub. No.: US 2026/0322931 A1
(43) Pub. Date: Oct. 15, 2026

(54) PRINT CONTROL SYSTEM, CONTROLLING METHOD FOR PRINT CONTROL SYSTEM, AND NON-TRANSITORY COMPUTER-READABLE STORAGE MEDIUM

(71) Applicant: CANON KABUSHIKI KAISHA, Tokyo (JP)

(72) Inventor: HIDEHARU SAWADA, Chiba (JP)

(21) Appl. No.: 19/635,535

(22) Filed: Mar. 31, 2026

(30) Foreign Application Priority Data
Apr. 9, 2025 (JP) 2025-064353

(51) Int. Cl. H04N 1/00; G06F 3/12

(52) U.S. Cl. CPC H04N 1/00676; G06F 3/1205; G06F 3/1258

(57) ABSTRACT

A print control system prints on paper a rectangular image equal to or larger than an output paper size so that no margin is formed on one side corresponding to a first side of the image, cuts the paper with the image printed thereon at two cut positions, the two cut positions corresponding to a second side and a third side as two sides of the image perpendicular to the conveyance direction and corresponding to the output paper size, and prints a mark indicating a cut position corresponding to a fourth side different from the first to the third sides, on a second paper portion of the paper to be cut from a first paper portion of the paper having the image printed thereon and including neither the second side nor the third side, the second paper portion including the second side or the third side of the image.

### BACKGROUND

### Field of the Technology

The present disclosure relates to a print control system, a controlling method for the print control system, and a non-transitory computer-readable storage medium.

### DESCRIPTION OF THE RELATED ART

Conventionally, there has been known borderless printing as a method for producing a borderless content image without requiring cutting. Especially, large-format printers generally perform borderless printing on roll paper, and thus both a printer driver and a printer maintain a list of roll-paper widths for which borderless printing is available and appropriately exchange print data. This makes it possible to produce a content image having no margins on the top, the bottom, the right, and the left sides. In the present disclosure, such printing without margins on the top, the bottom, the right, and the left sides is referred to as four-side borderless printing.

In recent years, there has been described a technique for achieving not only borderless printing on roll paper having a predetermined width but arbitrary borderless printing without regard to limitations on roll-paper widths.

In such a technique, by placing roll paper larger than print data in a printer and performing borderless printing, a printed product can be produced that has a margin only on the right side (i.e., without margins on the top, the bottom, and the left sides) or only on the left side (i.e., without margins on the top, the bottom, and the right sides). The application of such control allows the user to obtain a borderless content image simply by cutting the margin on one side even for a printed product having a size different from the width of the user's roll paper. In the present disclosure, such printing without margins on the top, the bottom, and the right sides or without margins on the top, the bottom, and the left sides is referred to as three-side borderless printing.

As a conventional technique used when the user cuts off a margin, Japanese Patent Laid-Open No. 2004-15641 describes a technique of arranging cut marks (e.g., register marks) around a content image to indicate cut positions.

Further, as a technique related to the three-side borderless printing, Japanese Patent Laid-Open No. 2020-140396 describes a technique of switching between the four-side borderless printing and the three-side borderless printing.

### SUMMARY

The present technique is directed to presenting cut positions in a more suitable manner at the time of three-side borderless printing.

According to an aspect of the present disclosure, a print control system includes at least one memory and at least one processor which function as a setting unit configured to set an output paper size, a print control unit configured to perform control so as to print on paper a rectangular image equal to or larger than the output paper size set by the setting unit so that no margin is formed on one side corresponding to a first side of the rectangular image between two sides of the paper parallel to a conveyance direction, a cutting control unit configured to perform control so as to cut the paper with the rectangular image printed thereon at two cut positions using a cutting unit under the control of the print control unit, the two cut positions corresponding to a second side and a third side as two sides of the rectangular image perpendicular to the conveyance direction and corresponding to the output paper size set by the setting unit, and a control unit configured to perform control so as to print a mark indicating a cut position corresponding to a fourth side different from the first to the third sides of the rectangular image, on a second paper portion of the paper to be cut by the cutting unit, the paper including a first paper portion and the second paper portion, the first paper portion having the rectangular image printed thereon and including neither the second side nor the third side, the second paper portion including the second side or the third side of the rectangular image.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a configuration of a computer device.

FIG. 2 illustrates an example of a functional configuration of a print control device.

FIG. 3 illustrates an example of a borderless printing setting dialog.

FIG. 4 illustrates an example of a print setting screen.

FIGS. 5A to 5E illustrate examples of output results of borderless printing.

FIG. 6 is a flowchart illustrating an example of processing of a printer driver.

FIG. 7 is a flowchart illustrating an example of processing of a printer.

FIGS. 8A and 8B illustrate examples of printed products.

FIG. 9 illustrates an example of an output result of marks and a guide on a printed product.

FIG. 10 illustrates an example of a message dialog.

FIGS. 11A and 11B illustrate examples of borderless printing settings dialogs.

FIG. 12 is a flowchart illustrating an example of processing of a printer driver.

FIG. 13 is a flowchart illustrating an example of processing of a printer.

FIGS. 14A and 14B illustrate examples of printed products.

FIG. 15 illustrates an example of a printed product with paper strips not cut off.

### DESCRIPTION OF THE EMBODIMENTS

In three-side borderless printing, a content image can be produced by cutting off the one side on which a margin remains from a printed product. However, it is difficult to identify a cut position in some cases. On the other hand, when a cut line is added to the printed product, the cut line remains inside the content image, which may worsen the appearance. In view of such a background, a method is required for indicating a cut position so that no cut line remains in the content image in three-side borderless printing.

Thus, in the present disclosure, a mechanism will be described that enables a cut position to be presented in a more suitable manner in three-side borderless printing.

Some embodiments of the present technique will now be described in detail with reference to the attached drawings. The following embodiments are not intended to limit the present technique pertaining to the scope of the claims, and not all of the combinations of features described in the embodiments are necessarily essential to the solution provided by the present technique.

Further, like numerals refer to like components, and the redundant descriptions will be omitted.

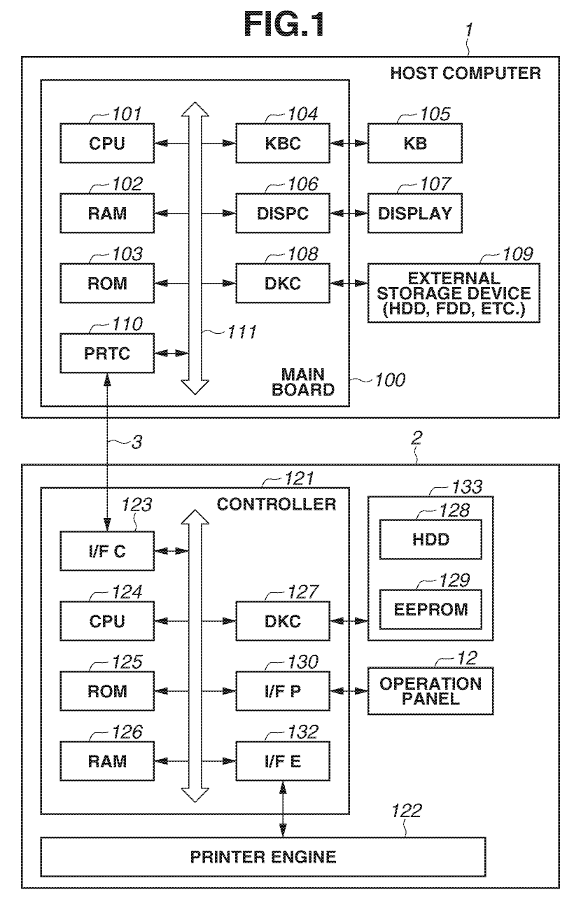

An example will be described of a configuration of a computer device according to the embodiments of the present disclosure with reference to FIG. 1. FIG. 1 is a block diagram illustrating an overview of a printing system including a host computer (hereinafter, also referred to as a host) 1 and an inkjet printer (hereinafter, also referred to as a printer) 2 as the representative embodiments of the present technique.

As illustrated in FIG. 1, the host 1 and the printer 2 are connected to each other via a predetermined bidirectional interface 3, such as universal serial bus (USB) and transmission control protocol/internet protocol (TCP/IP). Examples of the host 1 include a personal computer (PC).

The host 1 includes a main board 100 including a central processing unit (CPU) 101, a keyboard (KB) 105, a display 107, such as a liquid crystal display (LCD), and an external storage device 109, such as a hard disk drive (HDD) or a flexible disk drive (FDD). The main board 100 further includes a random access memory (RAM) 102, a read only memory (ROM) 103, a keyboard controller (KBC) 104, a display controller (DISPC) 106, a disk controller (DKC) 108, and a printer controller (PRTC) 110.

The CPU 101 generally controls the above-described components connected to a system bus 111 to execute various programs.

The KBC 104 controls input from the keyboard 105 and a pointing device (not illustrated). The KBC 104 is also referred to as an operation unit or an input unit. The DISPC 106 controls display of the display 107.

The RAM 102 functions as the main memory or a working area of the CPU 101.

The ROM 103 stores an operating system, programs for executing individual functions including a printer driver (described in detail below) according to the present embodiments, a boot program, various applications, and a printer control command generation program (hereinafter, also referred to as a printer driver), and the like.

The DKC 108 controls access to the external storage device 109, such as a hard disk drive or a flexible disk drive.

The PRTC 110 is connected to the printer 2 via the bidirectional interface 3 to control communication processing of data and commands between the printer 2 and the PRTC 110.

The printer 2, which includes a controller 121, a printer engine 122, an operation panel 12, and a nonvolatile storage device 133, is connected to the host 1 via the bidirectional interface 3.

The nonvolatile storage device 133 includes an HDD 128 or an electrically erasable programmable read only memory (EEPROM) 129. The nonvolatile storage device 133 may also be referred to as a nonvolatile memory.

The controller 121 includes a CPU 124, a ROM 125, a RAM 126, an interface controller (I/FC) 123, a DKC 127, a panel interface (I/FP) 130, and an engine interface (I/FE) 132.

The CPU 124 executes various programs. The ROM 125 stores programs that receive print image data and commands from the host 1 and control the printer engine 122 to perform optimum recording, and various data. The RAM 126 is used as a working area for temporarily storing various types of data and programs.

The I/FC 123 is connected to the host 1 via the bidirectional interface 3 to control communication processing of data and commands between the host 1 and the I/FC 123.

The HDD 128 stores data from the host 1 and a large amount of data, such as ancillary information about the data from the host 1. The EEPROM 129 stores, for example, information specific to a recording device to be used during a recording operation. The DKC 127 controls access to the nonvolatile storage device 133.

The I/FP 130 controls display on the operation panel 12 and input from the operation panel 12. The I/FE 132 controls the printer engine 122, which performs optimum recording by directly controlling the hardware.

In the present embodiments, while the printer engine 122 uses an inkjet recording method, an electrophotographic printer engine and an offset printing device may also be used.

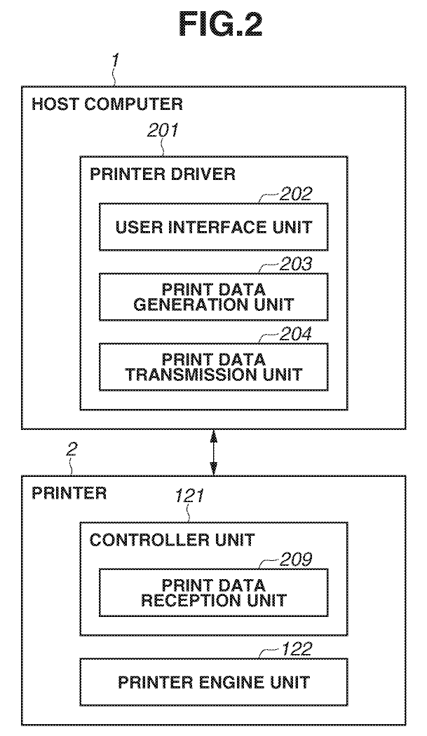

An example of a functional configuration of the print control device according to the embodiments of the present disclosure will now be described with reference to FIG. 2. The host 1 according to the present embodiments includes a printer driver 201 including several function modules.

A user interface unit 202 has a function of providing the user with a method for inputting print settings for the printer driver 201. The printer driver 201 causes the display 107 to display a print setting screen based on an instruction to display the print setting screen from the operating system. The user interface unit 202 stores therein information related to functions of the printer 2 and displays the print setting screen based on the information.

A print data generation unit 203 has a function of generating print data to be transmitted as a print job to the printer 2. The print data generation unit 203 converts a document prepared by the user into a data format interpretable by the printer 2 and generates control commands to perform printer control based on print settings configured via the user interface unit 202.

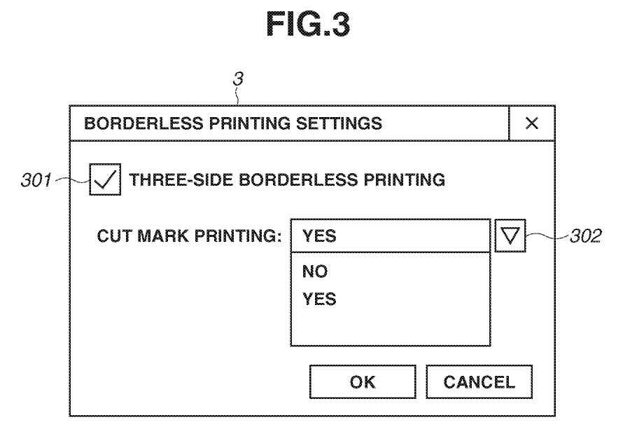

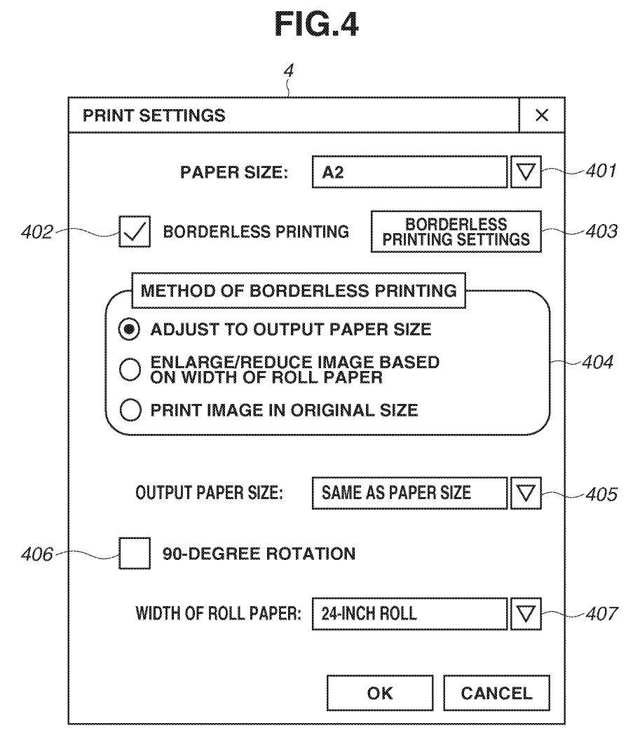

A print data transmission unit 204 transmits print data generated by the print data generation unit 203 to the printer 2. Further, the printer driver 201 according to the present embodiments includes a general print control unit and has functions of borderless printing and three-side borderless printing illustrated in FIGS. 3 and 4. Detailed descriptions of FIGS. 3 and 4 will be given below.

The printer 2 includes the controller 121 and the printer engine 122.

The controller 121 includes a print data reception unit 209. The print data reception unit 209 receives print data transmitted from the print data transmission unit 204.

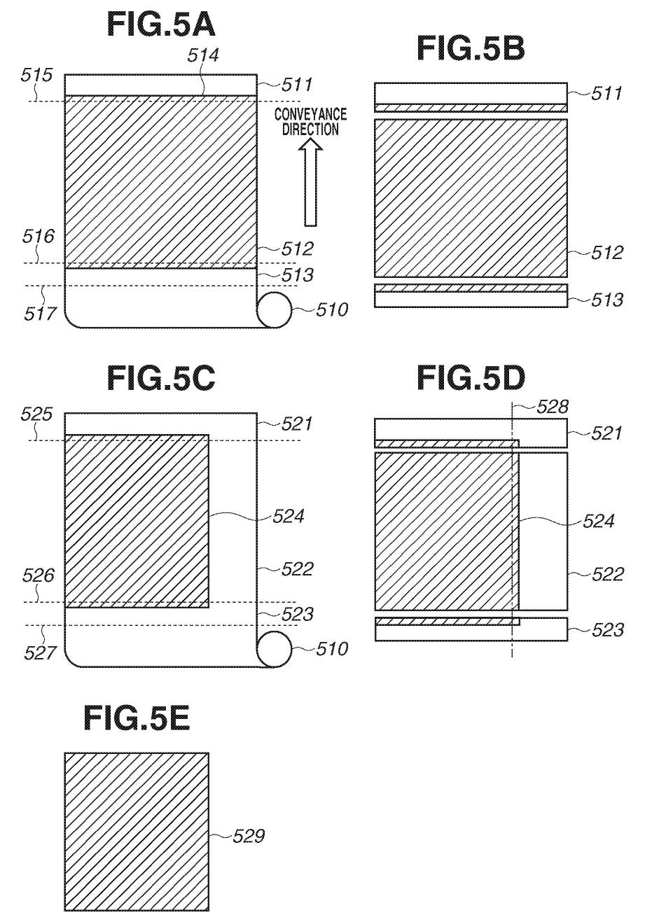

FIGS. 5A to 5E illustrate examples of output results of four-side borderless printing and three-side borderless printing. The arrow in FIG. 5A indicates the conveyance direction in which roll paper is conveyed during printing.

FIG. 5A illustrates an example of a case where four-side borderless printing is performed on roll paper having a 24-inch (609.6-mm) width with a content image enlarged to the full width of the roll paper.

FIG. 5B illustrates an actual printed product produced in FIG. 5A.

FIG. 5C illustrates an example of a case where three-side borderless printing at an A2 output size (420.0 mm × 594.0 mm) is performed on roll paper with a 24-inch (609.6-mm) width. FIG. 5D illustrates an actual printed product obtained in FIG. 5C.

The output result of four-side borderless printing illustrated in FIG. 5A will now be described. According to the present embodiments, roll paper 510 is 24-inch roll paper. Cut positions 515, 516, and 517 indicate positions to be cut by the printer 2. At the time when the roll paper is conveyed to a predetermined position during printing, the printer 2 sequentially cuts the roll paper with a cutter provided in the printer 2. Print data the user has instructed the printer 2 to print is actually printed on a content image 514. According to the present embodiments, cut pieces 511 and 513 cut for borderless printing are referred to as paper strips. Specifically, the cut piece 511 corresponds to the paper strip at the leading edge, and the cut piece 513 corresponds to the paper strip at the trailing edge.

FIG. 5B illustrates the paper strip 511 at the leading edge, a printed product 512 including a content image, and the paper strip 513 at the trailing edge, which are separated by the printer 2.

The output result of three-side borderless printing illustrated in FIG. 5C will now be described. Roll paper 510 represents roll paper similar to that in FIG. 5A, and is assumed to be 24-inch roll paper in the present embodiments. Cutting positions 525, 526, and 527 indicate positions at which the printer 2 performs cutting, and during printing, the roll paper is sequentially cut by the cutter provided in the printer 2 at the time when the roll paper is conveyed to a predetermined position. In a content image (a rectangular image) 524, print data the user has instructed to print is actually printed. Cut pieces 521 and 523 cut for borderless printing are paper strips. The cut piece 521 corresponds to the paper strip at the leading edge, and the cut piece 523 corresponds to the paper strip at the trailing edge.

FIG. 5D illustrates the paper strip 521 at the leading edge cut by the printer 2, a printed product 522 including a content image, and the paper strip 523 at the trailing edge.

As illustrated in FIGS. 5B and 5D, the paper strips are cut off so that the respective edges of the content images are included, allowing the cut sides of the content images to appear borderless.

On the other hand, printing is performed so as to slightly extend beyond the left edge of the finished area of a content image on the surface of roll paper, achieving borderless printing at the left edge. In this case, the ink that protrudes beyond the left edge of the finished area on the surface of the roll paper is absorbed at a borderless slot provided in the platen of the printer 2.

The user can obtain a content image 529 illustrated in FIG. 5E by cutting a cut position 528 of the printed product 522 including the content image using a ruler and a cutter, or using a dedicated paper cutting machine. The position of the cut position 528 is difficult to recognize, which is an issue of the present disclosure. The embodiments of the present disclosure will now be described in detail.

### First Embodiment

### During Print Setting

FIG. 3 illustrates an example of a borderless printing setting dialog used to switch between the four-side borderless printing and the three-side borderless printing according to a first embodiment of the present disclosure. A three-side borderless printing check box 301 is used to receive the user's instruction to switch the settings between the three-side borderless printing and the four-side borderless printing. Specifically, by checking the three-side borderless printing check box 301, the user is allowed to select an output paper size smaller than the set width of the roll paper. As a result, the three-side borderless printing is performed.

A cut mark printing drop-down list 302 is used to receive the user's selection whether to print a cut mark. The cut mark printing drop-down list 302 includes options "Yes" and "No". Processing of cut mark printing will be described in detail below.

FIG. 4 illustrates an example of a print setting screen according to the present embodiment. The screen illustrated in FIG. 4 is one of screens of the user interface unit 202 included in the printer driver 201. This screen is activated by an application or an operating system (OS) when print data created by the user is printed, allowing the user to configure print settings to obtain a desired printed product.

A paper size 401 is an input area for receiving the specification of a paper size of print data created by the user. In the example illustrated in FIG. 4, A2 (420.0 mm × 594.0 mm) is selected.

To perform borderless printing, the user checks a borderless printing check box 402. When the borderless printing check box 402 is checked in this manner, a borderless printing radio button 404 and a borderless printing settings button 403 are enabled, allowing the user to select a desired borderless printing method. An adjusted-to-output-paper-size setting is used to perform borderless printing based on the output paper size selected from the output paper size drop-down list 405. A printing-image-in-original-size setting is used to perform borderless printing without enlarging or reducing the document. An enlarged/reduced-image-based-on-roll-paper-width setting is used to perform borderless printing based on the width of the roll paper selected from a width of roll paper drop-down list 407. A 90-degree rotation check box 406 is used, when checked by the user, to perform printing after the image is rotated by 90 degrees. This setting for printing the image rotated by 90 degrees is used, for example, in a case where the image rotated by 90 degrees leads to saving paper.

### During Printing

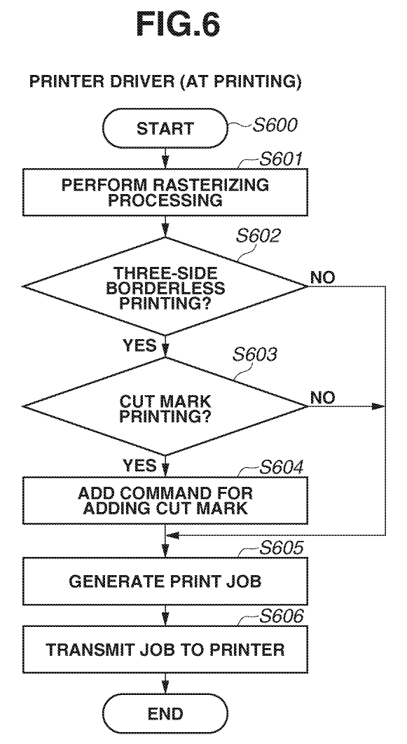

The user can issue a print instruction from an application after specifying desired settings via the user interface unit 202 illustrated in FIG. 4. FIG. 6 is a flowchart illustrating an example of processing S600 related to borderless printing of the printer driver 201 when printing is performed by an application. Each operation of the processing in the flowchart illustrated in FIG. 6 is performed by the CPU 101 of the host computer 1 loading a program stored in a storage area, such as the ROM 103 and the external storage device 109, into the RAM 102 to execute the program. In the following description of the operations of the processing illustrated in FIG. 6, the CPU 101 actually executes the processing. However, for convenience, the printer driver 201, which is activated by the CPU 101 executing the above program, is assumed to perform the processing.

When the user issues an instruction to execute printing to an application, in step S601, the printer driver 201 generates image data by rasterizing printing-target data based on a drawing command from the application. While the printer driver 201 rasterizes the printing-target data in this case, the printer 2 may rasterize the printing-target data depending on the capabilities of the printer 2.

In step S602, the printer driver 201 determines whether three-side borderless printing is specified in the print settings. As a specific example, the printer driver 201 may determine whether three-side borderless printing is specified by checking the check state of the three-side borderless printing check box 301 illustrated in FIG. 3. If the printer driver 201 determines that three-side borderless printing is specified in the print settings (YES in step S602), the processing proceeds to step S603. If the printer driver 201 determines that three-side borderless printing is not specified (NO in step S602), the processing proceeds to step S605.

In step S603, the printer driver 201 determines whether cut mark printing is set in the print settings. As a specific example, the printer driver 201 may determine whether the cut mark printing is specified, by checking the setting specified via the cut mark printing drop-down list 302 illustrated in FIG. 3. If the printer driver 201 determines that "Yes" is selected for cut mark printing (YES in step S603), the processing proceeds to step S604. If the printer driver 201 determines that "No" is selected for cut mark printing (NO in step S603), the processing proceeds to step S605.

In step S604, the printer driver 201 adds a print command for adding a cut mark to the print data.

In step S605, the printer driver 201 generates a print job based on the image data generated by rasterizing the printing target data in step S601 and the print command.

In step S606, the printer driver 201 transmits the print job generated in step S605 to the printer 2. The printer driver 201 then completes the processing in step S600 illustrated in FIG. 6.

Execution of the processing illustrated in FIG. 6 enables generating a print job for three-side borderless printing with a cut mark selectively included or omitted. In the example illustrated in FIG. 6, the processing branches based on the presence or absence of a cut mark command. However, a cut mark command (e.g., ON, OFF, or the like) may be added regardless of the presence or absence of a cut mark.

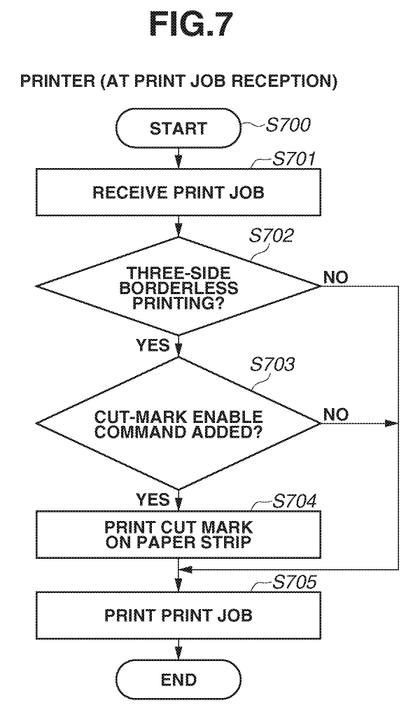

FIG. 7 is a flowchart illustrating an example of processing S700 performed by the printer 2 upon reception of print data from the printer driver 201. Each operation of the processing in the flowchart illustrated in FIG. 7 is performed by the CPU 124 of the printer 2 loading a program stored in a storage area, such as the ROM 125 and the nonvolatile storage device 133, into the RAM 126 to execute the program.

In step S701, the CPU 124 receives a print job from the printer driver 201 via the I/FC 123.

In step S702, the CPU 124 determines whether three-side borderless printing is set for the print job received in step S701. If the CPU 124 determines that three-side borderless printing is set for the print job (YES in step S702), the processing proceeds to step S703. If the CPU 124 determines that three-side borderless printing is not set (NO in step S702), the processing proceeds to step S705.

In step S703, the CPU 124 determines whether a cut-mark enable command is added to the print job. If the CPU 124 determines that a cut-mark enable command is added to the print job (YES in step S703), the processing proceeds to step S704. If the CPU 124 determines that a cut-mark enable command is not added to the print job (NO in step S703), the processing proceeds to step S705.

In step S704, the CPU 124 controls printing-related processing so that a cut mark is printed on a paper strip. The cut mark is controlled to be printed at a position corresponding to the width of an output paper size of the print job. For example, if the output paper size is A2 (420.0 mm × 594.0 mm), the CPU 124 controls printing-related processing so that the center of the cut mark is positioned at 420.0 mm from the left edge of the roll paper.

In step S705, the CPU 124 performs printing of the print job. At this time, if the setting for a cut mark is configured in step S704, the CPU 124 performs control so that a cut mark is printed at the set position. The CPU 124 then causes the cutter provided in the printer 2 to cut the printed product printed in step S705 and the printed product with a content image printed thereon to be discharged to a predetermined discharge destination. The CPU 124 then completes the processing S700 illustrated in FIG. 7.

Application of the control illustrated in FIG. 7 enables processing to be switched based on a cut mark command during three-side borderless printing, and enables, when a cut mark is added, the cut mark to be printed on a paper strip to be separated from the content image. Further, application of the control enables indicating a cut position while preventing the cut mark from being printed on the content image.

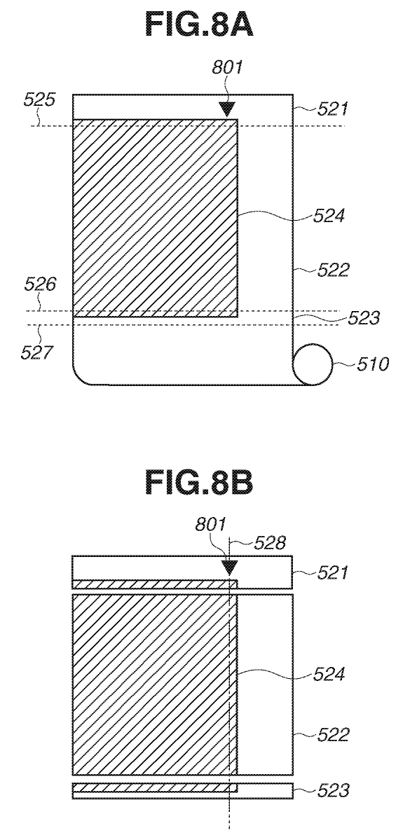

FIG. 8A illustrates an example of a printed product output after the completion of the processing described above with reference to FIGS. 6 and 7. FIG. 8B illustrates an example of a printed product after the paper is cut at the cut positions 525, 526, and 527 by the cutter provided in the printer 2. The roll paper 510, the paper strips 521 and 523, the printed product 522, the content image 524, and the cut positions 525 to 527 in FIG. 8B are similar to those in FIGS. 5A-5E, and detailed descriptions thereof will be omitted.

A cut mark 801 corresponds to the cut mark printed in step S704 in FIG. 7. The paper strip 523 at the trailing edge without a printed cut mark can be reduced in size compared with the paper strip 521 at the leading edge with a cut mark printed thereon. The user can easily cut the paper at a correct position by abutting, against an abutment portion of a dedicated cutting machine, the paper strip 521 at the leading edge with a cut mark printed thereon and the printed product 522 including the content image, and using the cut mark as a reference. In the present embodiment, the cut mark is illustrated as a triangular mark. However, this is merely an example, and the appearance of the cut mark is not particularly limited as long as the cut position can be indicated. As a specific example, the cut mark may be illustrated as a line or an arrow.

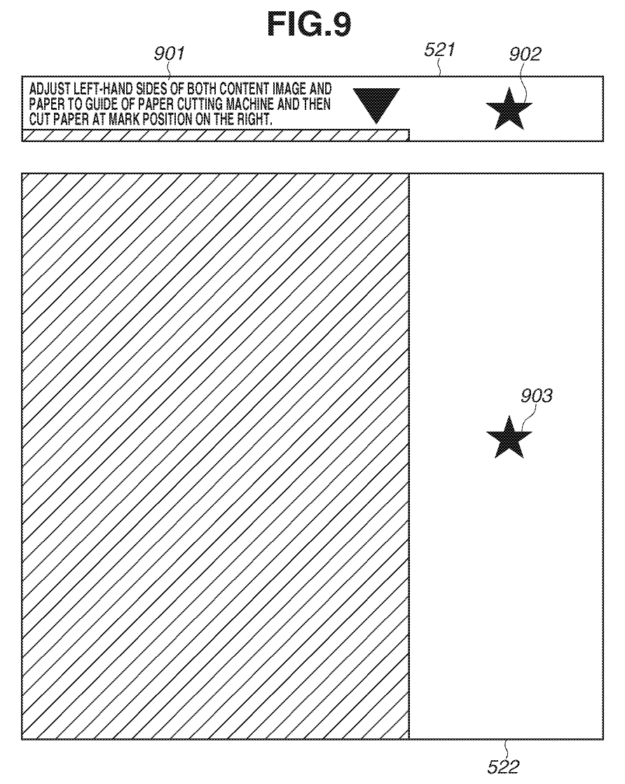

FIG. 9 is an enlarged view illustrating the paper strip 521 at the leading edge and the printed product 522 including the content image. Text 901 is instructional text on how to use a cut mark. Marks 902 and 903 indicate that the paper strip 521 at the leading edge and the printed product 522 including the content image form a pair. In the present embodiment, the marks 902 and 903 are illustrated as star symbols. However, this is merely an example, and the appearance of the marks is not particularly limited as long as the marks indicate that the paper strip 521 at the leading edge and the printed product 522 including the content image form a pair.

It is desirable for the marks 902 and 903 not to be the same as those of other print jobs or other pages. As a specific example, numeric values may be presented as the marks 902 and 903.

The text 901 and the mark 902 are printed in step S704 in FIG. 7, and the mark 903 is printed together with the cut mark and the content image in step S705 in FIG. 7. Application of such control prevents marks and instructional text from being printed in a case where a cut mark is not printed, and enables marks and instructional text to be printed in a case where a cut mark is printed. Although not illustrated, an option for selecting whether to print instructional text may be provided in the borderless printing setting dialog illustrated in FIG. 3 when no instructional text or marks are required. In this case, for example, in the processing of the printer 2 illustrated in FIG. 7, it is sufficient that switching processing is performed to switch whether to print instructional text and marks by referring to a command indicating whether printing of instructional text is required.

FIG. 9 illustrates the example with focus on the paper strip 521 at the leading edge. However, instructional text and marks can be printed on the paper strip 523 at the trailing edge.

In this manner, by printing instructional text for a paper strip, the user can be notified of how to use a cut mark printed on the paper strip, and erroneous disposal of the paper strip can be prevented. Further, printing marks facilitates association between the paper strip and the content image even in a case where cutting is performed after a plurality of printed products is printed.

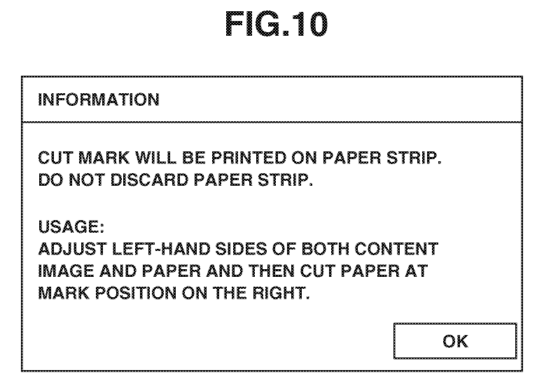

FIG. 10 illustrates an example of a message dialog for notifying the user that a cut mark is to be printed on a paper strip. The message dialog illustrated in FIG. 10 is displayed, for example, when the printer driver 201 confirms that "Yes" is selected from the cut mark printing drop-down list 302 illustrated in FIG. 3. Further, in step S704 illustrated in FIG. 7, the printer 2 can cause the operation panel 12 to display the message dialog illustrated in FIG. 10. Displaying such a message dialog enables the user to be notified that a cut mark is to be printed. Further, the effect of preventing erroneous disposal of a paper strip with a cut mark printed thereon can be expected.

### Second Embodiment

### During Print Setting

Generally, when a paper cutting machine is used, a cut position can be determined by abutting a paper strip with a printed cut mark and a content image against an abutting portion of the paper cutting machine. In this case, a single paper strip is sufficient. On the other hand, when cutting is performed using a ruler and a cutter, two reference points (e.g., cut marks) are required to determine the cut position, so that two paper strips with printed cut marks thereon are required. As described above, the required number of paper strips varies depending on the cutting method to be applied. In the present embodiment, an example will be described of switching processing based on a position at which a cut mark is printed and the selected cutting method. In the present embodiment, the description will be given focusing on the differences from the above-described first embodiment, and detailed descriptions of parts substantially the same as those of the first embodiment will be omitted.

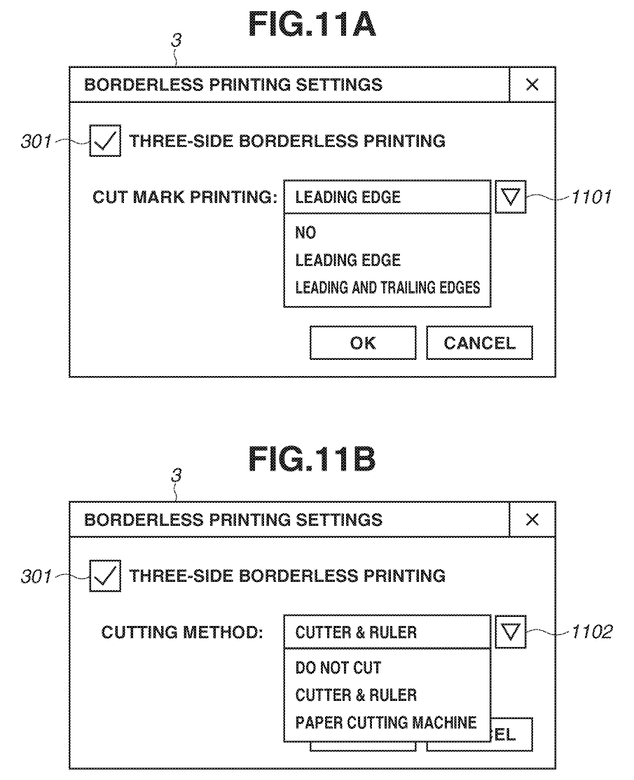

FIGS. 11A and 11B each illustrate the three-sided borderless setting dialog illustrated in FIG. 3 with the selection items in the cut mark printing drop-down list 302 changed.

A cut mark printing drop-down list 1101 allows the user to select the printing position of a cut mark from among "no", "leading edge", and "leading and trailing edges". A cutting method drop-down list 1102 allows the user to select a cutting method from among "do not cut", "cutter and ruler", and "paper cutting machine".

### During Printing

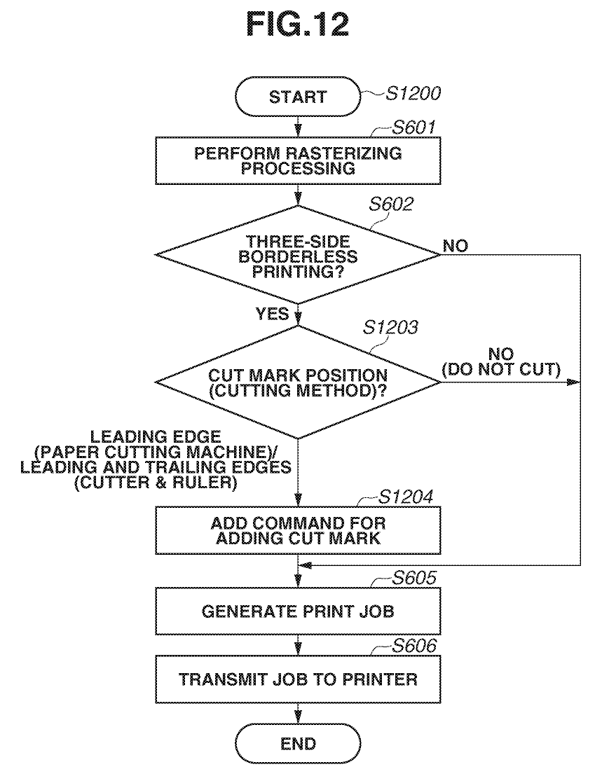

FIG. 12 is a flowchart illustrating an example of processing S1200 performed by the printer driver 201 at the time of printing according to the present embodiment. Each operation of the processing in the flowchart illustrated in FIG. 12 is performed by the CPU 101 of the host computer 1 loading a program stored in a storage area, such as the ROM 103 and the external storage device 109, into the RAM 102 to execute the program. In the following description of the operations of the processing illustrated in FIG. 12, the CPU 101 actually executes the processing described above. However, for convenience, the printer driver 201, which is activated by the CPU 101 executing the above program, is assumed to perform the processing. Further, the operations of steps S601, S602, S605, and S606 are substantially the same as those assigned the same reference numerals in the example illustrated in FIG. 6, and thus detailed descriptions thereof will be omitted.

After the completion of the processing of up to step S602, in step S1203, the printer driver 201 checks the setting of a cut mark position (cutting method). Specifically, the printer driver 201 checks the settings of the cut mark printing drop-down list 1101 and the cutting method drop-down list 1102 described above with reference to FIGS. 11A and 11B, respectively. If the printer driver 201 determines that the setting of a cut mark position (cutting method) is "No (do not cut)" in step S1203, the processing proceeds to step S605. If the printer driver 201 determines that the setting of a cut mark position (cutting method) is "leading edge (paper cutting machine)" or "leading and trailing edges (cutter and ruler)" in step S1203, the processing proceeds to step S1204.

In step S1204, the printer driver 201 adds a command corresponding to the cut mark printing (cutting method) to the print data.

Then, upon the completion of the processing in steps S605 and S606, the printer driver 201 ends the processing S1200 illustrated in FIG. 12.

Application of the above-described control enables a cutting method and the printing position of a cut mark selected by the user to be reflected in the command of the print job. In the example illustrated in FIG. 12, the processing branches based on a cut mark printing (cutting method). If the setting of a cut mark position (cutting method) is "No (do not cut)", a command is not added to the print job. However, the control is not limited thereto. As a specific example, even if the setting of a cut mark position (cutting method) is "No (do not cut)", a command indicating that the setting of a cut mark position (cutting method) is "No (do not cut)" is added to the print job.

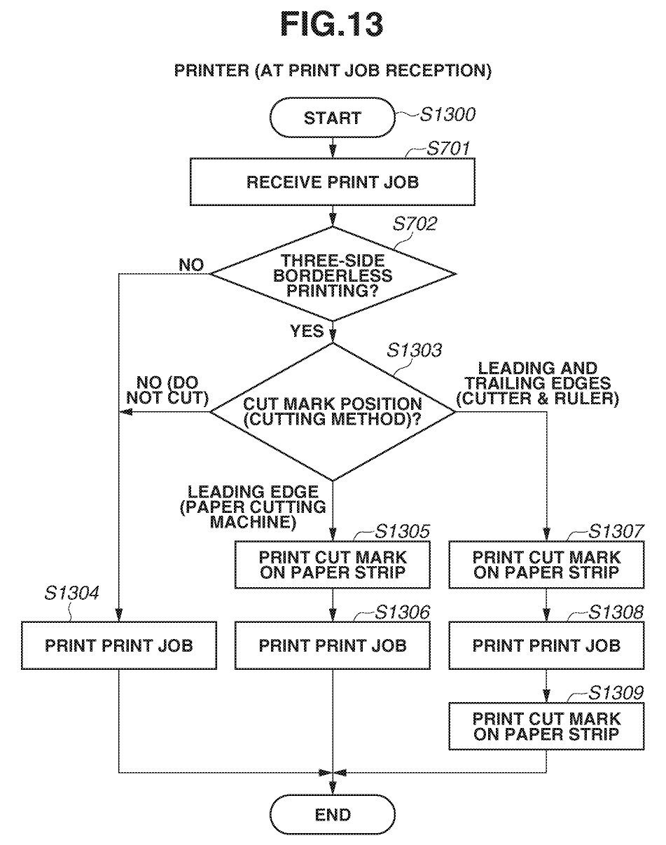

FIG. 13 is a flowchart illustrating an example of processing S1300 performed by the printer 2 according to the present embodiment. Each operation of the processing in the flowchart illustrated in FIG. 13 is performed by the CPU 124 of the printer 2 loading a program stored in a storage area, such as the ROM 125 and the nonvolatile storage device 133, into the RAM 126 to execute the program. The operations of steps S701 and S702 are substantially the same as those assigned the same reference numerals in the example illustrated in FIG. 7, and thus detailed descriptions thereof will be omitted.

After the completion of the processing of up to step S702, in step S1303, the CPU 124 checks the cut mark position (cutting method) command included in the print job.

If the CPU 124 determines that the setting of a cut mark position (cutting method) is "No" (do not cut) in step S1303, the processing proceeds to step S1304. In step S1304, the CPU 124 performs printing of the print job, and then completes the processing S1300 illustrated in FIG. 13.

If the CPU 124 determines that the setting of a cut mark position (cutting method) is "leading edge" (paper cutting machine) in step S1303, the processing proceeds to step S1305. In step S1305, the CPU 124 performs printing of a cut mark on the paper strip. In step S1306, the CPU 124 performs printing of the print job, and then completes the processing S1300 illustrated in FIG. 13.

If the CPU 124 determines that the setting of a cut mark position (cutting method) is "leading and trailing edges" (cutter and ruler) in step S1303, the processing proceeds to step S1307. In step S1307, the CPU 124 performs printing of a cut mark on the paper strip at the leading edge. In step S1308, the CPU 124 performs printing of the print job. In step S1309, the CPU 124 performs printing of a cut mark on the paper strip at the trailing edge, and then completes the processing S1300 illustrated in FIG. 13.

In this case, as in the operation of step S704 illustrated in FIG. 7, the printing positions of the cut marks printed in steps S1305, S1307, and S1309 are set to positions corresponding to the width of the output paper size of the print job.

Application of the above-described control enables a cut mark to be printed based on the setting of the cut mark position (cutting method). In addition, a cut mark can be printed on the paper strip at the trailing edge only when necessary, and thus the effect of saving ink and paper can be expected. By the user simply selecting a cutting method, the position at which a cut mark is printed is automatically determined. Further, a cut position can be indicated while preventing the cut mark from being printed on the content image.

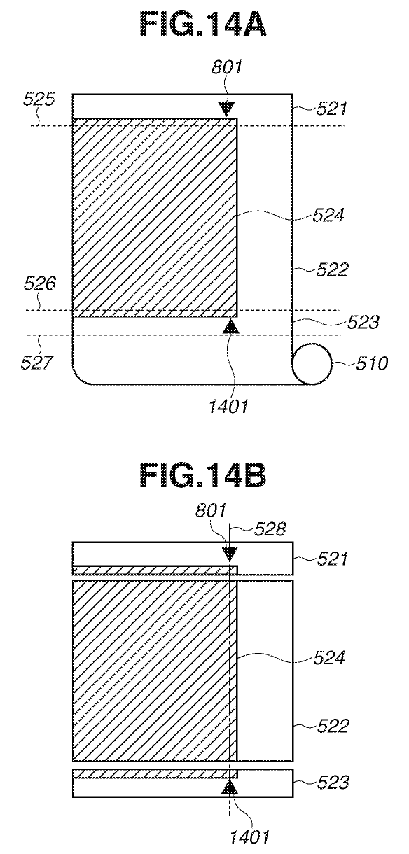

FIG. 14A illustrates an example of a printed product output after the processing according to the present embodiment is performed. FIG. 14B illustrates an example of a printed product produced by cutting the printed product illustrated in FIG. 14A at the cut positions 525, 526, and 527 using the cutter provided in the printer 2. The roll paper 510, the paper strips 521 and 523, the printed product 522, the content image 524, the cut positions 525 to 527, and the cut mark 801 illustrated in FIG. 14B are substantially the same as those assigned the same reference numerals in FIGS. 5 and 8, and thus redundant descriptions thereof will be omitted.

A cut mark 1401 is an example of the cut mark printed in step S1309 illustrated in FIG. 13 according to the present embodiment. When the user performs cutting using a cutter and a ruler, the cut position can be determined using the two cut marks on the paper strip 521 at the leading edge and the paper strip 523 at the trailing edge. Thus, the content image 524 can be cut out at an appropriate position from the printed product 522 including the content image 524.

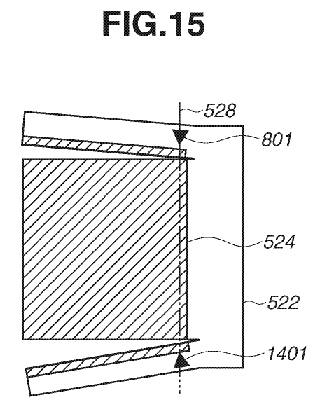

FIG. 15 illustrates an example in which, based on the example illustrated in FIG. 14B, the paper strips are not completely cut off from the printed product 522 by the printer 2. In the first and the second embodiments, a state is illustrated where the paper strips with cut marks printed thereon are cut off, but the paper strips do not necessarily need to be cut off.

For relatively large printed products, it may be difficult to abut a printed product against the abutting portion of a paper cutting machine, or when cutting is performed using a cutter and a ruler, it may be difficult to overlap a paper strip with the content image. In such a case, the paper strip at the leading edge and the paper strip at the trailing edge may not be completely, which is partly cut off, by the control of the printer 2. Although the procedure for cutting processing by the printer 2 is not illustrated, the cutting processing is performed by cutting at least the part from a cutting start position (the left edge according to the present embodiment) to the position corresponding to the output paper size using the cutter provided in the printer 2, and then returning the cutter to the cut position. Further, the printer 2 may be configured so that the amount of paper to be cut and the amount of paper not to be cut are adjustable. However, in view of separating the content image, it is desirable for at least the output paper size to be cut off.

Further, the above-described controls executed by the CPU 101 or the CPU 124 may be performed by a single piece of hardware. Alternatively, by a plurality of pieces of hardware (e.g., a plurality of processors or circuits) sharing processing, the entire apparatus may be controlled.

The present technique has been described above in detail based on the embodiments. However, the present technique is not limited to these specific embodiments, and various modifications and changes without departing from the gist of the present disclosure are also included in the present technique. Further, each of the above-described embodiments merely illustrates one embodiment of the present technique, and combinations of the embodiments can be made as appropriate.

In the embodiments described above, an example has been described in which the present technique is applied to a printing system as illustrated in FIG. 1. However, the present technique is not limited to this example. For example, the present technique is also applicable to an apparatus or a system capable of performing output of a printed product and cutting of the printed product. Further, the device described as the host computer 1 is not particularly limited as long as the device is capable of cooperating with a device corresponding to the printer 2. For example, the host computer 1 is not limited to a personal computer, and a personal digital assistant (PDA), a mobile telephone terminal, or the like may be employed.

According to the present disclosure, cut positions for three-side borderless printing can be presented in a more suitable manner.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064353, filed Apr. 9, 2025, which is hereby incorporated by reference herein in its entirety.

What is claimed is:

1. A print control system comprising:
at least one memory and at least one processor which function as:
a setting unit configured to set an output paper size;
a print control unit configured to perform control so as to print on paper a rectangular image equal to or larger than the output paper size set by the setting unit so that no margin is formed on one side corresponding to a first side of the rectangular image between two sides of the paper parallel to a conveyance direction;
a cutting control unit configured to perform control so as to cut the paper with the rectangular image printed thereon at two cut positions using a cutting unit under the control of the print control unit, the two cut positions corresponding to a second side and a third side as two sides of the rectangular image perpendicular to the conveyance direction and corresponding to the output paper size set by the setting unit; and
a control unit configured to perform control so as to print a mark indicating a cut position corresponding to a fourth side different from the first to the third sides of the rectangular image, on a second paper portion of the paper to be cut by the cutting unit, the paper including a first paper portion and the second paper portion, the first paper portion having the rectangular image printed thereon and including neither the second side nor the third side, the second paper portion including the second side or the third side of the rectangular image.

2. The print control system according to claim 1,
wherein the second paper portion includes the second side downstream of the third side of the rectangular image in the conveyance direction, and
wherein the control unit performs control so as not to print the mark on a third paper portion including the third side of the paper to be cut by the cutting unit.

3. The print control system according to claim 1, wherein the control unit performs control so as to print the mark on both the second paper portion and a third paper portion of the paper to be cut by the cutting unit, the second paper portion including the second side downstream of the third side of the rectangular image in the conveyance direction, the third paper portion including the third side.

4. The print control system according to claim 1,
wherein the at least one memory and the at least one processor further function as an input unit configured to receive a user’s input indicating a method for cutting the paper at a cut position corresponding to the fourth side not to be cut by the cutting unit, and
wherein, based on the cutting method received via the input unit, the control unit performs control in a different manner depending on printing the mark on both the second paper portion and a third paper portion or on either the second paper portion or the third paper portion of the paper to be cut by the cutting unit, the second paper portion including the second side downstream of the third side of the rectangular image in the conveyance direction, the third paper portion including the third side.

5. The print control system according to claim 4, wherein the input unit is configured to receive input of, as the cutting method, any one of a plurality of options including cutting using a paper cutting machine and cutting using a ruler and a cutter.

6. The print control system according to claim 1, wherein the cutting control unit performs control so that the first paper portion and the second paper portion are partly cut off.

7. The print control system according to claim 1, wherein the print control unit performs control so as to further print on the second paper portion a guide indicating usage of the second paper portion with the mark printed thereon.

8. The print control system according to claim 7, wherein the guide includes content that prompts a user not to discard the second paper portion before the fourth side is cut.

9. The print control system according to claim 1, wherein the at least one memory and the at least one processor further function as a display control unit configured to perform control so as to display on a display unit of the print control system a guide indicating usage of the second paper portion with the mark printed thereon.

10. The print control system according to claim 9, wherein the guide includes content that prompts a user not to discard the second paper portion before the fourth side is cut.

11. The print control system according to claim 1, wherein the control unit performs control so as not to print a mark indicating a cut position on the first to the third sides.

12. The print control system according to claim 1, wherein the mark is at least one of a triangular mark having a vertex indicating the cut position, a solid line indicating the cut position, and a broken line indicating the cut position.

13. The print control system according to claim 1, wherein an information processing device configured to transmit a print job to a printing device including the cutting unit includes the setting unit, the print control unit, the cutting control unit, and the control unit.

14. The print control system according to claim 1, wherein a printing device including the cutting unit and a printing unit configured to perform printing on a recording material includes the setting unit, the print control unit, the cutting control unit, and the control unit.

15. A controlling method for a print control system, the method comprising:
setting an output paper size;
performing print control so as to print on paper a rectangular image equal to or larger than the output paper size set by the setting so that no margin is formed on one side corresponding to a first side of the rectangular image between two sides of the paper parallel to a conveyance direction;
performing cutting control so as to cut the paper with the rectangular image printed thereon at two cut positions using a cutting unit under the control of the print control, the two cut positions corresponding to a second side and a third side as two sides of the rectangular image perpendicular to the conveyance direction and corresponding to the output paper size set by the setting; and
performing control so as to print a mark indicating a cut position corresponding to a fourth side different from the first to the third sides of the rectangular image, on a second paper portion of the paper to be cut by the cutting unit, the paper including a first paper portion and the second paper portion, the first paper portion having the rectangular image printed thereon and including neither the second side nor the third side, the second paper portion including the second side or the third side.

16. A non-transitory computer-readable storage medium storing instructions to cause a computer to execute a controlling method for a print control system, the method comprising:
setting an output paper size;
performing print control so as to print on paper a rectangular image equal to or larger than the output paper size set by the setting so that no margin is formed on one side corresponding to a first side of the rectangular image between two sides of the paper parallel to a conveyance direction;
performing cutting control so as to cut the paper with the rectangular image printed thereon at two cut positions using a cutting unit under the control of the print control, the two cut positions corresponding to a second side and a third side as two sides of the rectangular image perpendicular to the conveyance direction and corresponding to the output paper size set by the setting; and
performing control so as to print a mark indicating a cut position corresponding to a fourth side different from the first to the third sides of the rectangular image, on a second paper portion of the paper to be cut by the cutting unit, the paper including a first paper portion and the second paper portion, the first paper portion having the rectangular image printed thereon and including neither the second side nor the third side, the second paper portion including the second side or the third side.
